(19) United States
(12) Patent Application Publication
(10) Pub. No.: US 2008/0306951 A1
(43) Pub. Date: Dec. 11, 2008

(54) Method and System of Retrieving Avatar Data Unique to a User

(76) Inventor: Benjamin Rodefer, Corrales, NM (US)

Correspondence Address: SUGHRUE MION, PLLC, 2100 PENNSYLVANIA AVENUE, N.W., SUITE 800, WASHINGTON, DC, 20037, US

(21) Appl. No.: 11/667,375

(22) PCT Filed: Nov. 9, 2005
(86) PCT No.: PCT/US05/40634

§ 371 Date: Aug. 6, 2008

Related U.S. Application Data
(60) Provisional application No. 60/626,599, filed on Nov. 9, 2004.

(51) Int. Cl. G06F 17/30

(52) U.S. Cl. 707/9; 707/E17.001

(57) ABSTRACT

A method of retrieving avatar data unique to a user is provided. The method includes invoking an application and retrieving said avatar data from an avatar server. The avatar data is accessible from different types of devices, wherein the different types of data can be a game console or a personal computer.

This application claims priority from U.S. Provisional Application No. 60/626,599, filed on Nov. 9, 2004, the disclosure of which is incorporated herein in its entirety by reference.

### BACKGROUND OF THE INVENTION

1. Field of the Invention

The present invention relates to a method of retrieving avatar information unique to a user, to be implemented in a client application.

2. Description of the Related Art

Today, most game systems handle information related to particular characters by storing a preset number of fields to a local file (or in some game systems, on a server file). These fields are specific to the games capabilities, and any values outside what the game system is designed for are not allowed. As a player begins a game, vital statistics and appearance data are loaded from the file. Games that do not allow for appearance customization simply have a predefined set of primary character models, which contain all graphical data necessary for rendering the character and associated motions. Other games where the main character can be edited allow for a preset selection of characteristics, which are used to dynamically modify the model, such as changing colors on sections of the model, or patching together different wire frame models. In this way, a diversity of characteristics can be selected and a dynamic character can be loaded when the game is launched. When saving, the game will update the file with the statistics (and any possible changes to the visual appearance).

Due to the diversity of game engines (core software that handle the visual rendering of the representation), the central character may vary greatly in how it must be rendered due to the varying specifications of the game system. Therefore, there exists little standardization in the method of loading, customizing and rendering the primary game character.

Accordingly, there exists a need to provide a standardized method of loading, customizing, and rendering primary characters in games, or other types of applications. More generally, there exists a need to be able to load, customize, and render data specific to a user in games, or different types of applications.

### SUMMARY OF THE INVENTION

The present application provides a method and system of retrieving and/or transmitting avatar data unique to a user.

According to an exemplary embodiment of the present invention, there is provided a method of retrieving avatar data unique to a user. The method includes: invoking an application at a device; retrieving avatar data from an avatar server. The avatar data is accessible from different types of devices.

According to yet another exemplary embodiment of the present invention, there is provided a system of transmitting avatar data unique to a user. The system includes a device which invokes an application, and a server which provides said avatar data. The avatar data can be provided to different types of devices.

A computer readable recording medium can be provided for performing the above-described method of retrieving avatar data.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a diagram showing a user terminal connected to an avatar server via a network;

FIG. 2 illustrates a method of acquiring avatar information for a client application according to an exemplary embodiment of the present invention;

FIG. 3 illustrates a process by which a user, via an authorized client application, connects to an avatar server for authenticating both the user and the client program, according to an exemplary embodiment of the present invention;

FIG. 4 illustrates a process of retrieving data from an avatar according to an exemplary embodiment of the present invention; and

FIG. 5 illustrates a process of transferring avatar data to a different medium according to an exemplary embodiment of the present invention.

### DETAILED DESCRIPTION OF THE INVENTION

Hereinafter, exemplary embodiments of the present invention will be described in detail with reference to the accompanying drawings.

The implementation of an avatar system should revolve around flexibility and adaptability among many different styles of software and hardware. The concept of an avatar is flexible enough to represent, for example, the identity of a user in any manner including visual recognition, audible recognition, name identification, unique number identification or any combination thereof. A piece of software which interfaces with information contained in an avatar must have the capabilities built into the system which allow communication with the database containing and managing the avatar data itself. An avatar can be any number of qualities defined by either the user or the software (“my” appearance, vital statistics, physical attributes, visual qualities, performance statistics, et cetera) and these qualities can be communicated through the software in update intervals. The avatar in essence becomes an evolutionary database which contains whatever user information pertains to the unique identity of that avatar.

Primarily a piece of software needs to be able to query the avatar data source as required and obtain the vital unique user information from that avatar for use in it's own particular implementation thereof. For instance, a piece of chat software could securely establish a connection with the avatar software/hardware and request name, location, vital statistics and screen name, while requesting none of the visual qualities also included in the avatar database. A 3D game world application could make a similar query to the database but, using a unified development environment, be able to make the same query to the avatar system and retrieve not only the textual information inherent to a particular avatar but also vital statistics which can be pushed down into the game world itself to modify the look and feel of the avatar visually. This can be accomplished by implementing unique and modular artwork for each potential property retrieved from the avatar database (blue eyes vs. brown eyes, for instance) or by using artwork which is adaptable to those properties in real time, for instance a default grey eye image which can be adjusted in code to match an RGB value given to it by the avatar system, or a 3D skeleton which dynamically reshapes itself to the height, weight and other properties defined by a user in their avatar.

The avatar database may also contain image data pertaining directly to the owner of that avatar, for instance a facial photograph. This data could be mapped directly to a 2 dimensional or 3 dimensional character to represent the actual visage of the avatar directly and actively in an interactive environment.

An important aspect of the avatar system is a universality among the types of queries it can receive from software and the type of data it can accept. The information stored must remain universal among software so that the data can move fluidly from application to application. This can be accomplished by establishing a development environment which includes a universal ‘language’ of interface and a method of verification which determines whether or not incoming information related to a given avatar is valid.

The control of an avatar in a virtual environment should be left up to the application itself. This allows the data itself to me non-modal and universal. Thus a three dimensional avatar can be controlled in whatever fashion the software allows, and the avatar data itself is not tied into the implementation of that data. This allows a wide range of applications for the avatar data and does not limit it's use to games, entertainment, chat environments, instant messaging, or any other typical interactive environment. The data can be brought into virtually any application to be used as a method of identification, authentication, or customization.

Exemplary embodiments of the present invention provide a system, method, computer software machine and/or hardware which allows a computer user or computer system to create a unique persistent portable personal virtual avatar or avatars for use in any virtual setting, including commercial outlets, computer or home console games or online social computing environments. An avatar(s) may have any combination of user defined and system defined characteristics which in combination create a unique entity to be used as a user's interface to any type of virtual or digital medium, community, or entertainment.

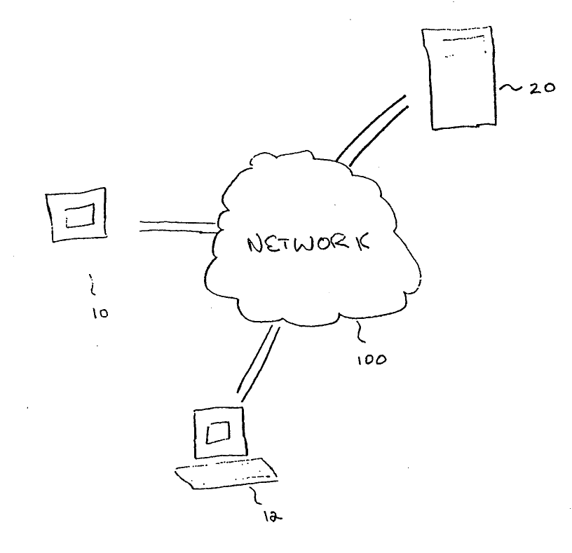

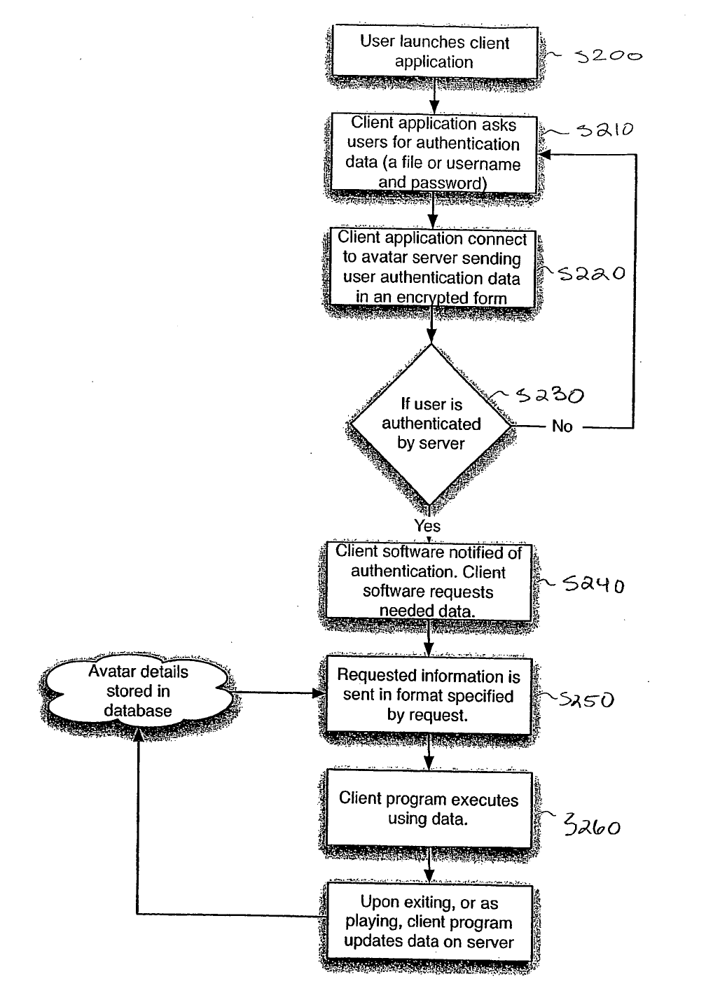

FIG. 1 is a diagram that illustrates a network of user terminals and an avatar server, in which the user terminals communicate with the avatar server in accordance with the process described in FIG. 2. The user terminals 10, 12 and avatar server 20 can be connected over a local area network 100, wide area network (not shown), or any other network that allows communications between user terminals and servers.

FIG. 2 shows an exemplary embodiment of a process of retrieving avatar data. According to FIG. 2, a user can launch a client application (S200). The client application then asks the user for authentication data (S210). The client application contacts the avatar server 20 and sends authentication data entered by the user (S220). The authentication data can be sent in an encrypted format. The authentication data can be verified at the avatar server (S230). Alternatively, other entities besides the avatar server 20 can be used to verify the authentication data. For example, the encrypted authentication data can be sent to a separate, or remote server, that is only dedicated to verifying authentication data, and then the results of this verification process can be provided to the avatar server 20. If the authentication data is verified, the client application can be notified of authentication, and then the client application can request the needed data (S240). The requested data is then sent to the client application (S250). For example, the requested data can be provided by the avatar server 20. The client application can then be executed using the requested data from the avatar server 20 (S260). The data on the avatar server can be updated by the client application either upon exiting the client application or while the client application is executing. Therefore, any changes made during the execution of the client application with respect to the data provided from the avatar server can dynamically be reflected in the avatar server 20 and reflected in any other applications that request such data.

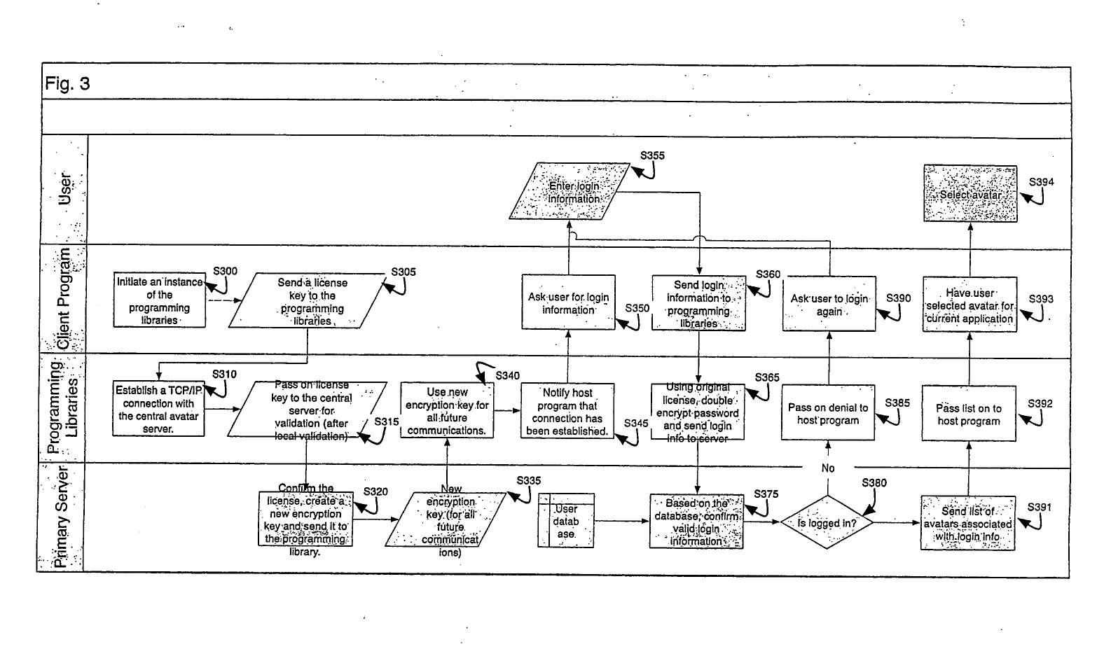

FIGS. 3-5 are flowcharts illustrating exemplary processes related to the present invention. In the flowcharts, communications between the client program or the transfer application and the primary avatar server can be mediated by a set of programming libraries. These programming libraries offer a standardized way for client applications to interface with the information stored on the primary avatar server, in a secure and efficient manner without requiring effort by the developers of the client program. In addition, the programming libraries serve to improve security by overseeing all information exchange.

FIG. 3 depicts a process by which a user, via an authorized client program, connects to the avatar server and authenticates both the user and the client program. The authentication described in FIG. 3 is similar to the authentication described above in step S230 of FIG. 2. Upon completion of the authentication, a list of avatars associated with the user account can be transmitted back to the client program, providing the user the opportunity to select the avatar that he/she wants to use inside the client program.

For example, as shown in FIG. 3, the client program can initiate the programming libraries S300 and provide them with the license key S305, which was provided to the developers of the client application as a means of ensuring only authorized program are able to connect to the avatar server. Upon confirming the validity of the license file (ensuring that it corresponds with the program and that the format is valid), a client application can open a TCP/IP or UDP connection with the primary avatar server S310 and transmit the key S315. A secondary confirmation can be run by checking that the license key is in fact still a valid key by the primary server S320, allowing for programs that misuse or compromise the avatar service to be at least temporarily disabled. The license key is then used to perform a handshake, where the server and the programming library create an encryption key S330, which will be used to secure all future communications S340. The client program is then notified at this stage, that a connection was successfully established between the programming library and the primary avatar server S345. The client program can then proceed to request login information from the user S350, which when entered S355 will be returned to the programming library S360. As the login information is critical to the security of that user's avatars, the encryption of this information is critical when transmitting it to the server S365. Upon retrieving the login information, the avatar server checks the validity and access of the user S375 based on the information in the user database. If no matching user is found or the user's access has been disabled (i.e., due to a security breach), then the programming library is notified S380, which in turn notifies the client application S385. The user is then asked on to enter their authentication information again S390. On the other hand, if the authentication process succeeded, a list of avatars associated with the provided login information is then sent to the programming library S391, which is then transmitted to the host program S392. The user is then asked to select S393 which avatar to use within the current instance of the client application S394, or alternatively the user can create a new avatar. An avatar to use within the client application can now be chosen, which the client program must retrieve the appropriate details for.

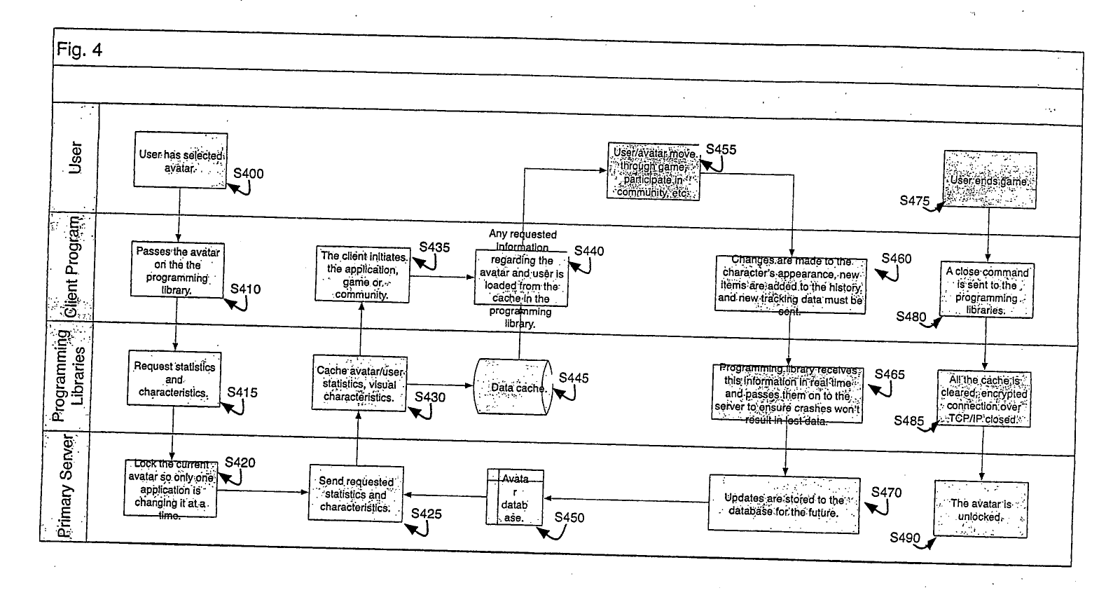

After having selected an avatar, the client program is now ready to request the necessary avatar details, which vary depending on the function of the client program. An exemplary process of retrieving data from the avatar is shown in FIG. 4. For example, games will require graphical/appearance information that will be crucial in the rendering of the avatar within the game environment. A game might also require game specific (not global to all client applications) statistics, such as experience points or something similar. On the other hand, a chat application will just need a name and maybe an icon. The primary avatar server will prepare the necessary information, package it and transfer it to the client application. As changes are made to the avatar (i.e., new story points in the game or new chat logs to store), they are transmitted back to the primary avatar server, where the changes are appended to existing avatar information.

Upon the user selecting the avatar to use S400, the client application requests a specific set of data from the avatar database S410 via the programming library. The primary avatar server locks necessary fields, so that the same avatar cannot be simultaneously used in two different client applications that seek to update the same fields S420. Reading from the avatar database 450, which contains all details for the avatar (name, statistics, logs, graphical representations and appearance data, as well as game specific information), the server prepares all information that the client application has requested. The data can then be packaged into an archive like file, offering minor compression (if the file is over a certain size). The archive format serves to hold many different and varying file formats (database like information, graphical data, etc) by offering a medium for combining multiple files. The archive has a hash table at the beginning which stores the file names stored in the archive along with their position in the archive, so that the when read, the client program can quickly jump to the specified field/file/information. This information is transmitted back to the programming library S430, which will then cache the archive locally S445 so that it can easily be accessed at anytime (but only the programming library can access it, to ensure the file integrity is not compromised). At this point, the client application initiates its primary function S435, requesting data S440 from the programming libraries when needed (which is extracted and passed in its raw format to the client program). Requests for information can specify the data type in addition to the actual data needed (data conversions will be handled at the primary avatar server), ensuring that a diversity of applications and mediums can interface with the data stored within the avatar database. The user will be able to use their avatar to interact with the environment S455 created within the client application (whether a game, a chat environment or another form). As avatar statistics or details change and new data is appended to logs 460, it will be transmitted back to the programming library S465, which creates an identical format archive (only containing the files/fields that need updating, to minimize bandwidth usage), which also contains a change log serving as a redundancy to make sure that all changes are replicated on the server. The new archive is then transmitted to the server (encrypted, as always, to prevent cheating/hacking attempts by the user to modify or jeopardize the accuracy of their character data), which processes it and makes changes S470 to the avatar in the database. This process continues throughout the client programs operation, ensuring that data on the server is always up to date (in case the connection is lost). When the user terminates the client application S475, the client application notifies the programming library to shut down its connection S480. The programming library cleans up the cache and closes the existing communication with the primary avatar server S485, which in turns unlocks any locked avatar fields S490 allowing for them to be changed again.

An exemplary implementation of the above-explained process follows. A game application might request a wire-frame vector map of the avatar, so that it can render the specific shape/visual characteristics necessary to render the avatar's unique visual appearance within its graphical environment. The wire-frame model, designed previously by the user, is stored within the avatar database. Depending on the details of the request, the server may convert the model to a different file format, to ensure that the client program can easily interface with it. The file will then be added to the archive with the name “appearance/wireframe.model”. The archive will then be transmitted and stored by the programming library. As the client application is trying to render the user's avatar, it will request the file “appearance/wireframe.model” from the programming library, knowing that the file was included in the archive because it was originally requested. The programming library will extract the file and provide it to the client application.

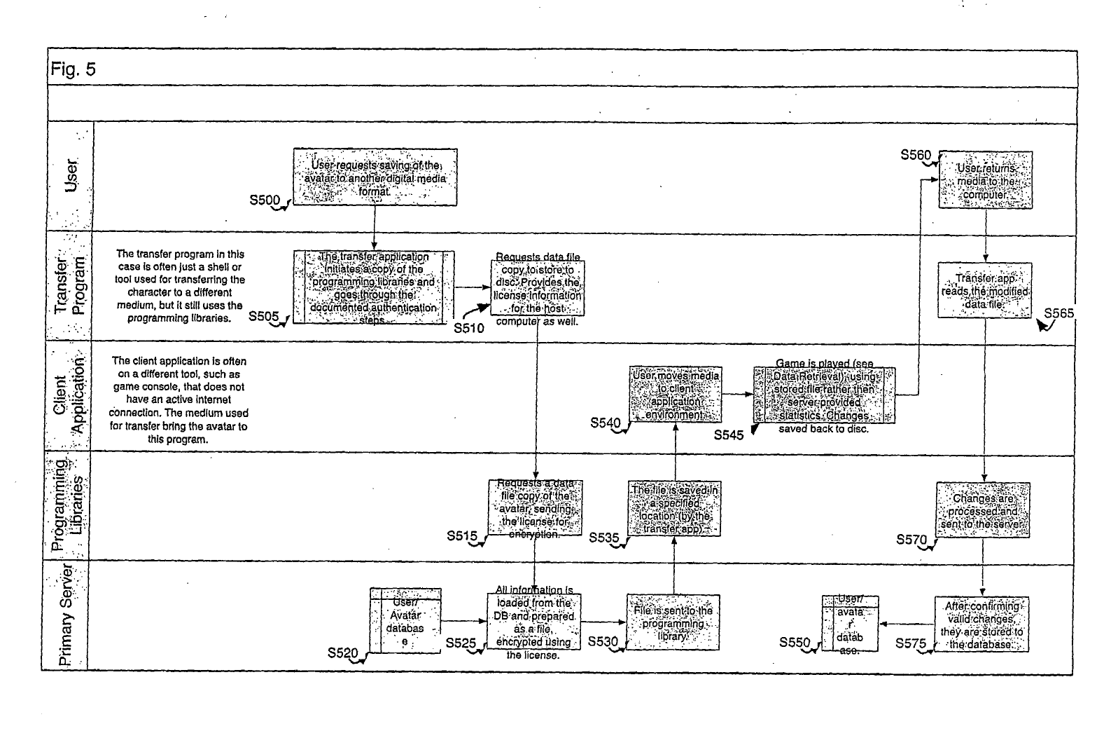

If the avatar is taken to a different medium that may not have network connection capabilities, then an alternate system can be used (e.g., synchronizing the avatar details onto a portable media card, whether a memory storage unit, a flash card or memory built into the device itself). This enables an avatar to be played on a portable game (i.e., PSP), with changes being synchronized the next time the device is able to connect with the programming library/central server. Based on the possibility of the avatar being transferred to another medium, FIG. 5 illustrates an exemplary process in which the client application has a persistent connection to the programming libraries/server and introduces another aspect, that being a transfer program, which retrieves the information from the programming libraries and prepares them for the other medium.

The user initiates the transfer application, requesting that a specific avatar is copied to their alternate media S500. After authenticating the user and selecting an avatar S505 based on the documented steps, the transfer program then requests the specific files and fields just as a normal client application would do S510, but here the transfer application must request all possible files as subsequent requests are not possible. The programming library then sends the requests to the servers S515, which load the information requested from the database and prepare an identical archive file S525. This archive file is then sent to the programming libraries S530, which is saved to a location specified by the transfer application S535, but the data is encrypted using the license key to ensure that the only valid changes to the file will be made by the actual client application. The media can then be moved to the alternate console or environment S540, where the client application can access the pre-prepared data in the archive file based on the archive specifications S545. In addition, the client application can update files and fields stored in the archive as well. When the media is returned to the transfer program S560, the transfer program will read all the changes S565 and send them back to the server via the programming libraries S570. When the server receives the changes, it checks their validity and then updates S575 the avatar database.

The above-described exemplary embodiments of the present invention may be embodied in a computer readable recording medium, as will now be explained.

On a practical level the software, that enables the computer system to perform the operations described in detail herein, may be supplied on any one of a variety of media. Furthermore, the actual implementation of the approach and operations of the invention are actually statements written in a computer language. Such computer language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media”, or “computer-readable media”, as used here, may include a diskette, a tape, a compact disc, an integrated circuit, a ROM, a CD, a cartridge, a memory stick or card, a remote transmission via a communications circuit, or any other medium useable by computers, including those now known or hereafter developed. For example, to supply software for enabling a computer system to operate in accordance with the invention, the supplier might provide a disc or might transmit the software in some form via satellite transmission, via a direct telephone link, or via the Internet. Thus, the term, “computer readable medium” is intended to include all of the foregoing and any other medium by which software may be provided to a computer.

Although the enabling software might be “written on” a disc, “embodied in” an integrated circuit, “carried over” a communications circuit, “stored in” a memory chip, or “loaded in” a cache memory, it will be appreciated that, for the purposes of this application, the software will be referred to simply as being “in” or “on” the computer readable medium. Thus, the terms “in” or “on” are intended to encompass the above mentioned and all equivalent and possible ways in which software can be associated with a computer readable medium.

The foregoing embodiments and advantages are merely exemplary and are not to be construed as limiting the present invention. The description of the present invention is intended to be illustrative, and is not intended to limit the scope of the claims. Many alternatives, modifications, and variations will be apparent to those skilled in the art.

What is claimed is:

1. A method of retrieving avatar data unique to a user, said method comprising:
invoking an application at a device; and
retrieving said avatar data from an avatar server,
wherein said avatar data is accessible from different types of devices.

2. The method according to claim 1, further comprising:
requesting authentication data from said user;
providing said authentication data to said avatar server;
determining whether said user is authenticated, based on said authentication data; and
if said user is authenticated, transmitting said avatar data to said application and executing said application using said avatar data.

3. The method according to claim 2, wherein said avatar data is updated at said avatar server at least one of after exiting said application and during the execution of said application.

4. The method according to claim 1, wherein said different types of devices include a personal computer and video game console.

5. The method according to claim 1, wherein said user specifies specific avatar data to be retrieved by entering information at said device.

6. The method according to claim 1, wherein said avatar data is provided to said different types of devices in different formats.

7. A system of transmitting avatar data unique to a user, said system comprising:
a device which invokes an application;
a server which provides said avatar data,
wherein said avatar data is provided to different types of devices.

8. The system according to claim 7, wherein said user provides authentication data to said server, and if said user is authenticated, said avatar data is transmitted to said application.

9. The system according to claim 8, wherein said avatar data is updated at said server at least one of after exiting said application and during the execution of said application.

10. The system according to claim 7, wherein said different types of devices include a personal computer and video game console.

11. The system according to claim 7, wherein said user specifies specific avatar data to be retrieved.

12. The system according to claim 7, wherein said avatar data is provided to said different types of devices in different formats.

13. A computer readable recording medium storing a program for performing a method of retrieving avatar data unique to a user, said method comprising:
invoking an application at a device; and
retrieving said avatar data from an avatar server,
wherein said avatar data is accessible from different types of devices.

14. The computer readable recording medium according to claim 13, wherein said method further comprises:
requesting authentication data from said user;
providing said authentication data to said avatar server;
determining whether said user said user is authenticated, based on said authentication data; and
if said user is authenticated, transmitting said avatar data to said application and executing said application using said avatar data.

15. The computer readable recording medium according to claim 14, wherein said avatar data is updated at said avatar server at least one of after exiting said application and during the execution of said application.

16. The computer readable recording medium according to claim 13, wherein said different types of devices include a personal computer and video game console.

17. The computer readable recording medium according to claim 13, wherein said user specifies specific avatar data to be retrieved by entering information.

18. The computer readable recording medium according to claim 13, wherein said avatar data is provided to said different types of devices in different formats.

19. The computer readable recording medium according to claim 13, wherein said retrieved avatar data is compressed.

20. The method according to claim 1, wherein said retrieved avatar data is compressed.
